(19) United States
(12) Patent Application Publication
(10) Pub. No.: US 2026/0143239 A1
(43) Pub. Date: May 21, 2026

(54) METHOD FOR ASSESSING ILLUMINATION SET-UP FOR VEHICLE SYSTEM CALIBRATION

(71) Applicant: BELRON INTERNATIONAL LIMITED, Egham (GB)

(72) Inventors: Chris Davies, Egham (GB); Gwen Daniel, Egham (GB)

(73) Assignee: BELRON INTERNATIONAL LIMITED, Egham (GB)

(21) Appl. No.: 19/119,709

(22) PCT Filed: Sep. 13, 2023
(86) PCT No.: PCT/GB2023/052369

§ 371 Date: Apr. 9, 2025

(30) Foreign Application Priority Data
Oct. 14, 2022 (GB) 2215167.4

(51) Int. Cl. H04N 23/71; G06T 7/194; G06T 7/80; G06V 10/28; G06V 10/60; G06V 20/56; H04N 17/00; H04N 23/74

(52) U.S. Cl. CPC H04N 23/71; G06T 7/194; G06T 7/80; G06V 10/28; G06V 10/60; G06V 20/56; H04N 17/002; H04N 23/74; G06T 2207/10024; G06T 2207/30252; G06V 2201/07

(57) ABSTRACT

The present invention relates to a method for assessing illumination set-up for vehicle system calibration. The invention in one aspect utilises a machine vision process using an imaging device for imaging a calibration target in an illumination set up and processes the image in order to identify illumination problems. If illumination problems are identified, the illumination set up is amended and/or the target repositioned with respect to the vehicle and/or the illumination set up, and the target is then re-imaged.

The present invention relates to a method for assessing illumination set-up for vehicle system calibration.

Vehicle advanced driver assistance systems (ADAS) such as windscreen mounted cameras require re-calibration from time to time. For example, where a camera is mounted to a windscreen which is replaced (as a result of crack damage or otherwise) then the camera will need to be re-calibrated following fitment to, and of, the replacement windscreen. Typically, this may involve the camera imaging a specific calibration target (typically a target board) provided for the make and/or model of the vehicle.

During ADAS camera calibration, the calibration target board is used as a reference point for ensuring that the camera lines up to the driving axis which indicates that the camera can sense a complete view of the road and upcoming vehicles. Usually, if the calibration board is not well-lit, the ADAS camera will be unable to detect the target board patterns correctly. This implies that the calibration system will fail to calibrate since it depends on the detected patterns and their respective position to calibrate the ADAS camera.

Therefore, to avoid failure of the calibration process, it is important to assess the target board for the possible presence of illumination problems such as uneven illumination, shadowing and saturation. The intention is that this process is carried out before calibration and if an illumination problem exists, the board will be repositioned to a space where illumination on the target board no longer poses a problem to the calibration system. The invention provides a procedure for a vehicle technician to assess whether the vehicle and calibration target are suitably positioned in an illumination set up to assure that a good chance of the re-calibration procedure succeeding.

In a broad aspect the invention therefore provides a machine vision process of imaging a calibration target in an illumination set up, in order to identify illumination problems, and if illumination problems are identified, amending the illumination set up, or repositioning the target, and re imaging the target. The procedure is repeated until the imaging process provides a result that the illumination is satisfactory for the recalibration process to proceed. Following this the recalibration procedure is commenced.

The process can be defined as:
i) providing a calibration target and positioning the calibration target with respect to a vehicle;
ii) providing an illumination set up for illuminating the calibration target;
iii) operating an imaging device to image the target and processing the image to assess whether the illumination is satisfactory to proceed to a calibration phase;
iv) when the output of step iii) is that the illumination is satisfactory; proceeding to implement the recalibration phase.

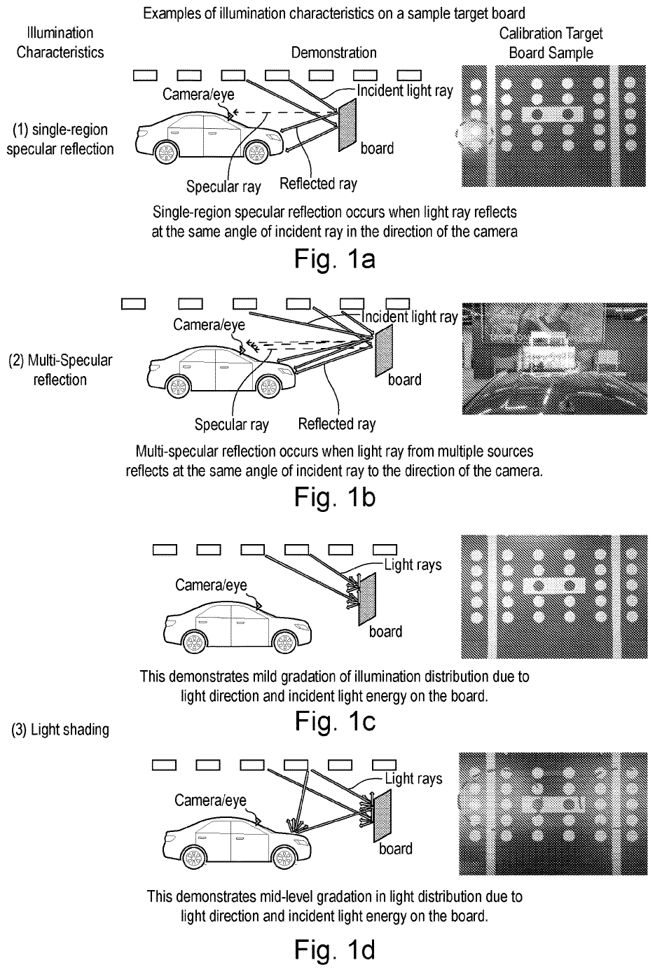

Since the calibration target board can potentially be lit by multiple ambient lights, there are several characteristics of light reflection that are possible on the target board. These are 1) single-region specular reflection, 2) multi-specular reflections, 3) gradation of light, 4) shadows, and 5) spotlight. Typically, illumination characteristics 1, 2, 4 and 5 can result in an image with uneven illumination while 3 can result in poor quality saturated images. These illumination characteristics are described and can be visualized in FIG. 1.

The imaging device comprises device such as a smartphone, having a camera and processor.

Processing the image may involve the steps of:
i) detection of saturation and uneven illumination (SU) regions in a calibration target image and;
ii) quantifying how much the calibration target of interest deviates from its reference sample that would pass the calibration test.

A processing step may be included in which the image is processed to remove background objects separate from the calibration target.

A processing step may operate according to an algorithm in which different illumination characteristics are taken into consideration.

The different illumination characteristics may be a combination comprising two or more of the hue, saturation and value (HSV) colour system and a thresholding to determine the luminosity of each pixel of a calibration target, formed by incoming light, and a reflectance property of the calibration target material.

A processing step may use a reference image to compute target image deviation from a satisfactory illumination reference image for the given calibration target using the mean squared difference (MSD) function. The satisfactory illumination reference image may be an image of a well-lit target board that is known to have passed a calibration test. The reference image may be stored in memory.

A processing step may operate according to an alternative contrast loss detection algorithm; preferably in which the distribution of illumination on calibration target areas is analysed.

In the process, the following steps may be present:
i) an object detection method is used to locate calibration target areas in an image;
ii) an illumination free image is calculated with respect to the calibration target area; and
iii) distribution of light is derived subsequently by calculation.

A process step may apply a metric to describe the unevenness of light, and a heat map may be generated to display the gradient of light reflected across the calibration target area.

The invention will now be further described in specific embodiments by way of example only and reference to the accompanying drawings.

FIG. 1 shows schematically common problems that arise in relation to illumination of calibration targets;

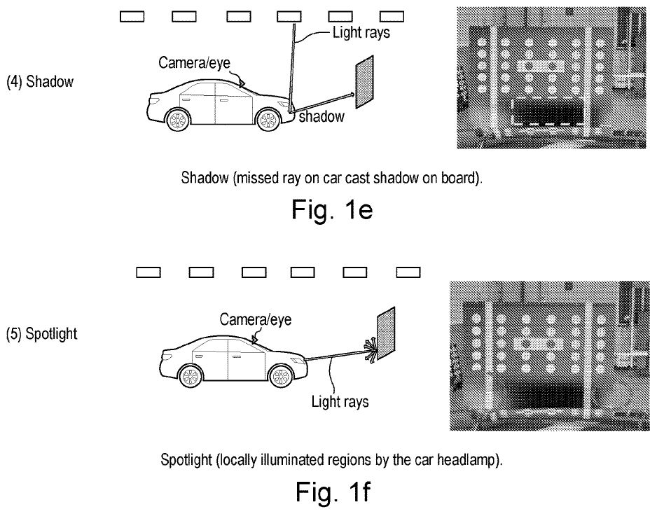

FIGS. 2 to 6 relate to implementation of a processing system using a first method/algorithm, in accordance with the invention; and,

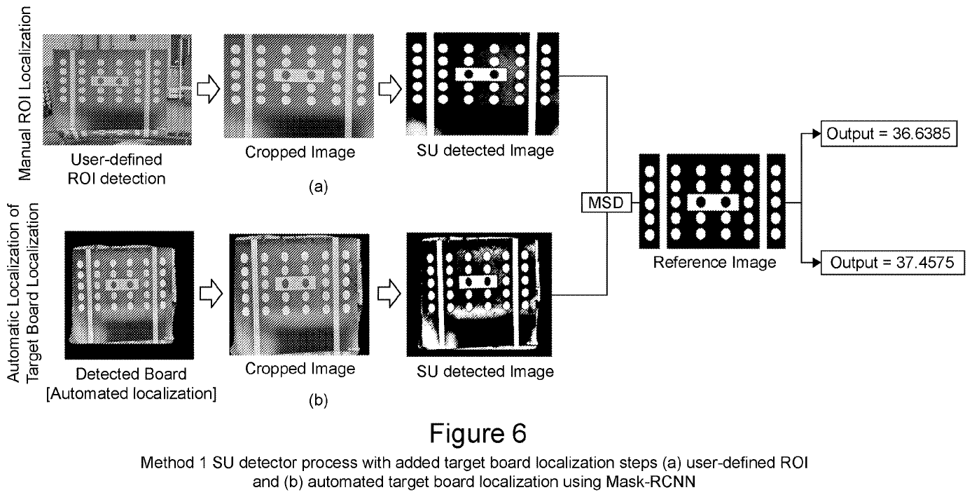

FIGS. 7 to 13 relate to implementation of a processing system using a second method/algorithm, in accordance with the invention.

### METHOD 1

In a first method of the invention the procedure is as set out in FIG. 2. Two main steps, detection of saturation and uneven illumination (SU) regions in a target board image and quantifying how much the target board of interest deviates from its reference sample that would pass the calibration test. A pre-processing step may be added as a supporting tool to help declutter an image containing background objects. This is possible when the focus of the calibration is no longer based on the viewpoint of the ADAS camera. It should be noted that the method can detect SU (saturation and uneven illumination) on a target board image even with the presence of environment clutter. Method 1 is summarized in FIG. 2 and briefly discussed as follows.

The SU algorithmic steps take into consideration the different illumination characteristics presented in section 2. It is based on a strategic combination of the hue, saturation and value (HSV) colour system and a thresholding to determine the luminosity of each pixel of a target board, L(x,y), formed by two unknowns, incoming light, I(x,y) and the reflectance property of the board material, R(x,y). This is given as:

$$L ( x , y ) = I ( x , y ) R ( x , y )$$

Let L(x,y)∈ [symbol] ³ in HSV space. To find pixels corresponding to specular highlight (single-point and multiple point), presence of saturation, shadowing, spotlights, only the domain L(x,y)∈ [symbol] ² is sampled which belongs to saturation Lₛ(x,y) and value Lᵥ(x,y) and if properly explored with thresholding, the objective can be achieved.

$$Q ( x , y ) = ( \text{?} - \text{?} ) * ( \text{?} - \text{?} )$$

$$\text{?} ( x , y ) = \text{?} ( x , y ) \leq {T}_{s} , and$$

$$\text{?} ( x , y ) = \text{?} ( x , y ) \geq {T}_{v}$$

$$\text{?} \text{indicates text missing or illegible when filed}$$

where Tₛ and Tᵥ are the threshold values for the saturation and value vectors Lₛ(x,y) and Lᵥ(x,y) and Cᵥ and [symbol] is a constant and control value, respectively. It should be noted that Q(x,y) still retains pixels in the range [0, 255] after processing. a reference image is used to compute how much a target board image of interest deviates from a general illumination norm for the given board using the mean squared difference (MSD) function. The idea behind a reference is based on the fact that there will always be an example of a well-lit target board that passed a calibration test. This reference is to be stored in a file and used for each target board, otherwise it will be difficult to quantify how a given target board image deviates from the norm with a well-lit illuminated version of itself. This is mathematically computed as:

$$rnsd ( x , y ) = \frac{1}{\vert {N}_{xy} \vert} {\sum }_{i ∈ {N}_{xy}} {( Q ( x , y ) - R ( x , y ) )}^{2}$$

where N_{xy} is the resolution of the image, Q(x,y) contains pixel regions of uneven illumination and poor saturation, and R(x,y) represents reference example of calibration-pass image.

Pre-processing comprises two computational solutions. A first method is manual region of interest (ROI) localization and automated target board localization in a cluttered background image. The manual localization allows user selection of an ROI when the image is captured during calibration in real-time.

A second method utilises automated target board location and can use an instance segmentation model (Mask-RCNN) already trained on all possible examples of target boards to localise the board of interest from an image captured during calibration in real-world. Both methods can be negligible if the interest of the user is only to detect the region on the board with illumination problem. The option to localize the board in a cluttered background can be activated on user request.

### Examples

The results presented here demonstrate how effective the SU detection algorithm is in identifying pixels corresponding to specular highlights (single-point and multiple point), poor saturation, shadows, and spotlights in a given image. For each performance scenario, a sample of the illumination problem that describes the illumination challenges of the given target board input image to the SU detector is presented, followed by the result of applying our SU detector and then the degree of deviation value is computed between the SU detected image and a reference image.

### Performance Scenario 1

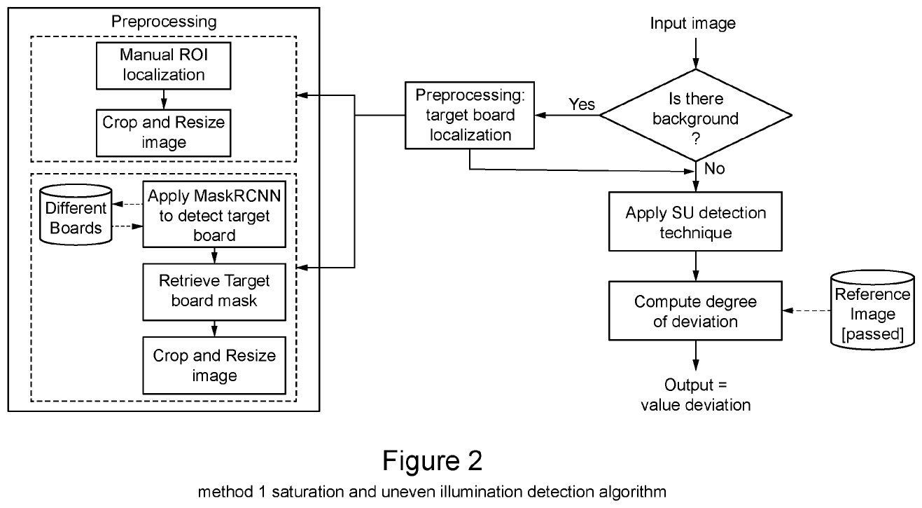

In this scenario the results of SU detector process for illumination challenges from mild to severe gradation in lighting and shadow are presented in FIG. 3 and discussed as follows. It can be observed that the SU detector was able to retrieve the regions of the target board image that are highly likely to lead to calibration failure, though the severe case of gradation in lighting might not be possible because there are lighting standards that are followed in calibration workshops to ensure excessive lighting imbalance do not occur. It can easily be observed with degree of deviation computation, such as the MSD (mean squared deviation), that the output value corresponds to the observable level of illumination problem present in a target board image.

### Performance Scenario 2

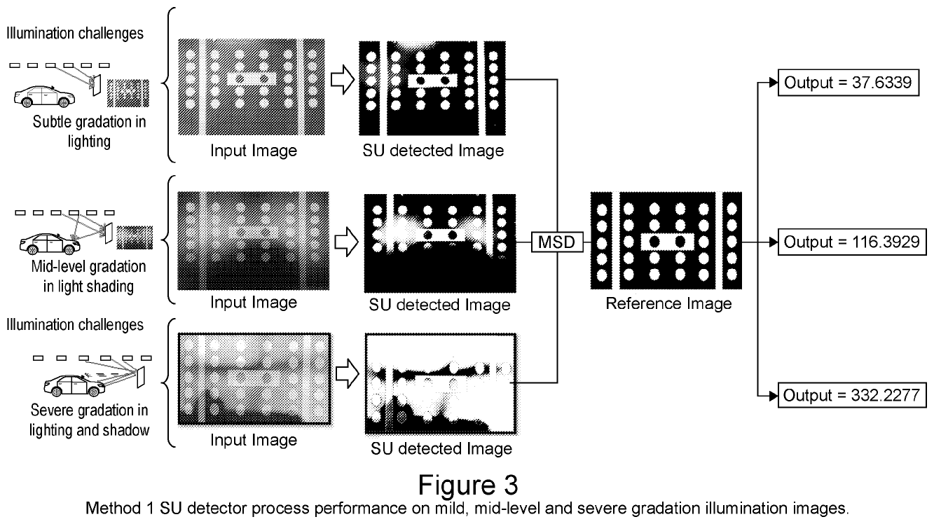

In this scenario, illumination challenges in the form of specular highlight are presented. The specular highlight is a significant problem that cannot be overlooked because of the material the target board is made-of and the multiple light sources surrounding the target board. This problem is more likely to be the root cause of calibration failure in the workshop than other illumination problems. In FIG. 4 are the performances of the SU detector on a single-point specular reflection image (generated in the lab) and a multi-specular reflection image. Even though an experienced technician can tell from the multi-specular reflection image that calibration will fail, it is still necessary to be able to quantify the failure rate due to the image deviation from a norm. As can be observed in FIG. 4, the SU detector was able to clearly show that the single-point specular highlight image, can result in failure of the calibration system. This is quite interesting because it was not obvious from its input that the leftmost circles where the highlight occurred can lead to calibration failure. By quantifying the problem using the MSD, it is resolved that the deviation of the single-point specular highlight when compared to the expected norm is high.

### Pre-Processing Feature

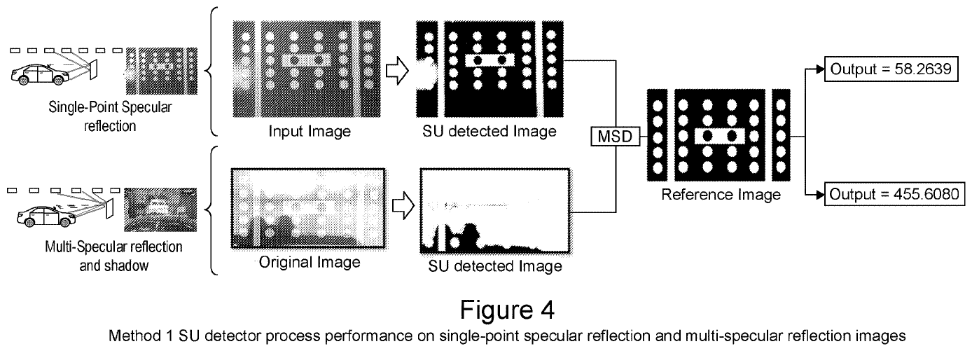

The results of added pre-processing steps to the SU detection algorithm (the option to localize the board in a cluttered background) can be seen in FIG. 5. The pre-processing can provide advantage but may not be necessarily employed in all implemented systems because the SU detector is able to detect regions of illumination problem on a given target board image with or without background clutter (see FIG. 4). However, for completeness, the performance of the SU detector with addition of the target board localization steps are demonstrated in FIG. 5.

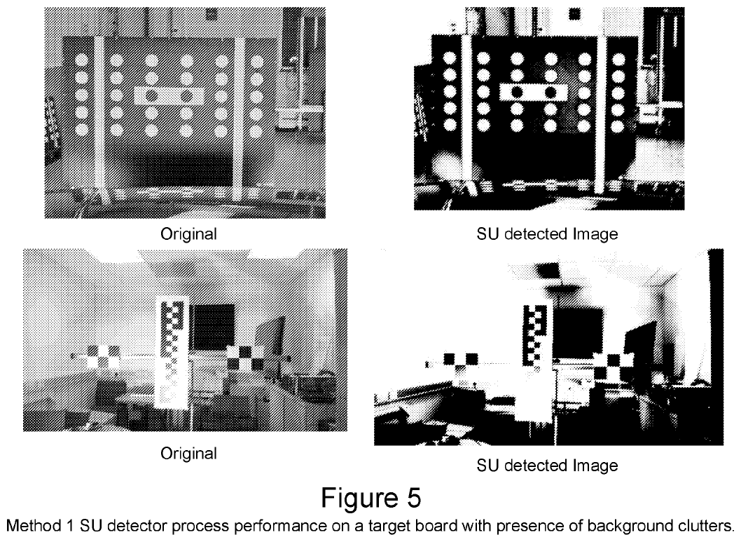

FIG. 6 shows that both automated and manual localisation methods can localize the target board and still yield closely related results. However, they both place different levels of computational demands on the SU detector. The automated target board localization using Mask-RCNN method places more computational demand than the user-defined ROI method, even though it can be trained to be able to detect and localize different target boards.

### METHOD 2

In a second method of the invention the procedure is as set out in FIG. 7. In this method an alternative contrast loss detection algorithm is utilised. The idea of this algorithm is based on analysing the distribution of illumination on the calibration target areas. The general process of the algorithm is shown in FIG. 7. Initially, an object detection method is used to find the calibration target board areas in an image. Then, an illumination free image is calculated with respect to the board area. The distribution of light is derived subsequently. Finally, a metric is applied to describe the unevenness of light, and a heat map generated to display the gradient of light reflected across the board area.

### Calibration Target Detection

In order to use the minimum computational power to detect the calibration target board in the photo taken by a smart phone, a process known as template matching is used. Normalized cross correlation (M) is the metric used to calculate the similarity between an image I and a template t, which is defined as:

$$M ( u , v ) = \frac{{\sum }_{x , y} [ I ( x , y ) - {\overline{I}}_{u , v} ] [ t ( x - u , y - v ) - \overline{t} ]}{{\{ {{\sum }_{x , y} [ I ( x , y ) - {\overline{I}}_{u , v} ]}^{2} {{\sum }_{x , y} [ t ( x - u , y - v ) ]}^{2} \}}^{\frac{1}{2}}}$$

where t̅ is the average of template image, and I_{u,v} is the average in the region under the template t. Once the normalized cross correlation M is calculated, the best matching area can be found by returning the index of maximum element in M. However, since there are multiple templates and the size of the board area may vary in the image, this process should be executed for several times to find the correct size and location of the board.

### Calculating Local Illumination Free Image

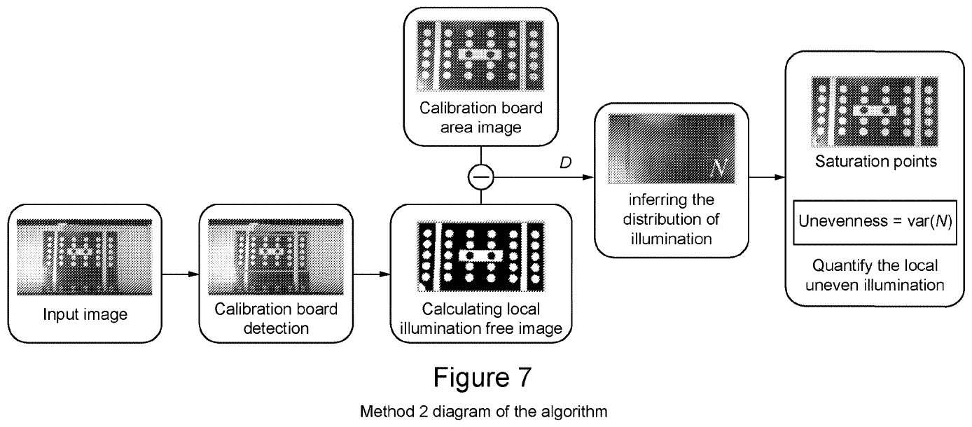

The illumination free image is an ideal image (or pseudo idealised board image) with all regions identically lit. Calculating the illumination free image of a real scene is challenging, but it is simplified in this method due to the prior knowledge of the target calibration boards as used by different vehicle manufacturers. Most of the target calibration boards only consist of white and black regions, so based on that, the illumination free image is derived by customised adaptive thresholding. FIG. 8 demonstrates the major steps in illumination free image calculation.

Before applying the adaptive thresholds, the background mode (white or black background) is decided according to the output i from the previous board detection process. Once the background is defined, a binary image is generated by adaptive thresholding as shown by the second image in FIG. 8. However, the binary image cannot be used as an illumination free image because the black and white pixels lack colour information. To retrieve the missing colour, the white pixels in it are assigned with the average value for the corresponding white pixels in the original image. Similarly, black pixels in the middle image are reassigned with a value from averaging the dark pixels in the original image. Therefore, the third image in FIG. 8 is created as the idealised illumination free image

### Inferring the Distribution of Illumination

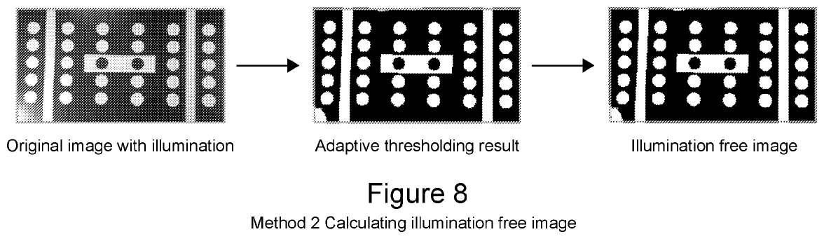

Theoretically, and in some practical situations, the illumination map D could be simply obtained by subtracting the illumination free image in FIG. 8 from the original image. However, the pattern on the calibration target board can cause different reflectance between the black region and white region, so an interpolation is necessary for fixing any incorrectly predicted illumination of the foreground areas—for example, the black regions in these cases. The interpolation algorithm is using an arithmetic sequence to fill all the wrong pixels at the foreground regions in the illumination map, where the arithmetic sequence is generated with reference to two neighbourhood ending pixels in D. FIG. 9 illustrates the way to interpolate the illumination map.

### Quantifying the Local Uneven Illumination

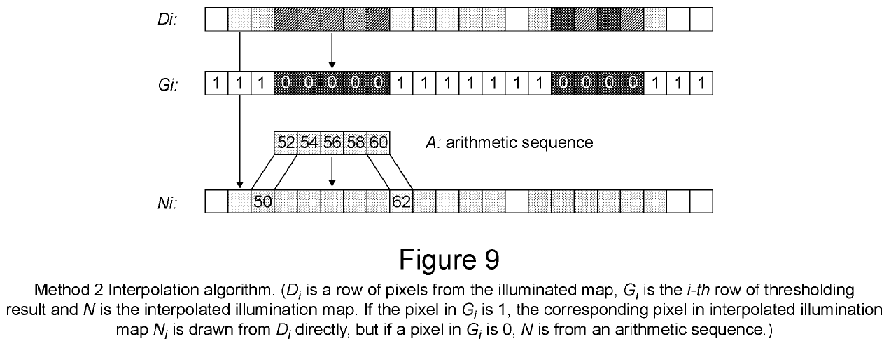

Once the greyscale interpolated illumination map N is calculated, we rendered this map with the Jet colormap, which made the change of illumination more visible to human eyes as displayed in FIG. 10. To describe the unevenness of the illumination on the calibration board, a variance is used to quantify it, which is defined as:

where N is the interpolated illumination map and N̅ is the mean pixel value. E_{(xy)} is the averaging operation over the image plane.

### Method 2 Results

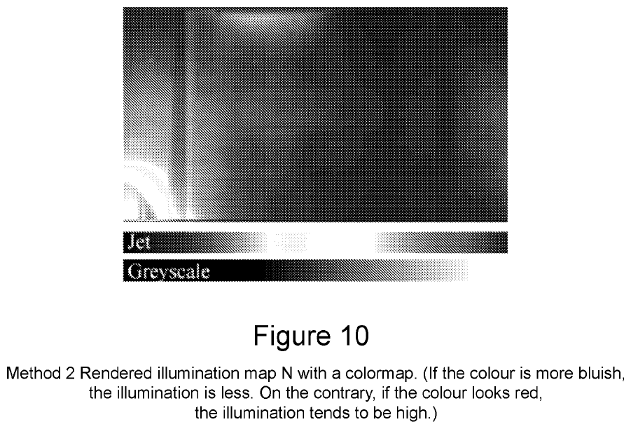

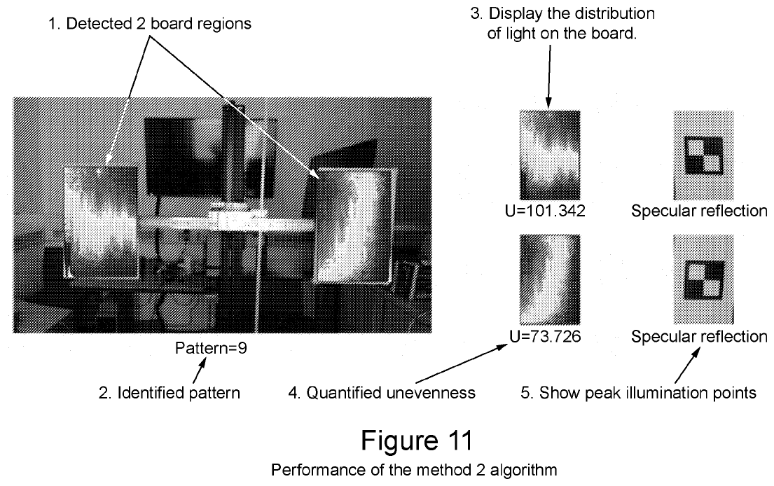

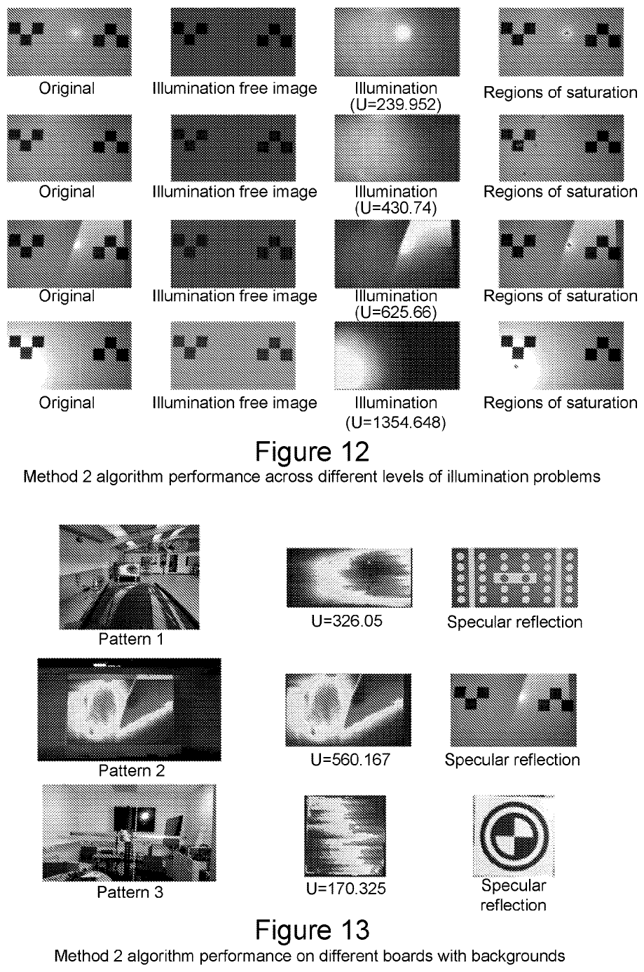

Experiments were designed to evaluate the algorithm under a simulated calibration environment of the workshop. In order to build a dataset for this evaluation, a smart phone was used to take pictures of the calibration boards from different view angles and under various illuminations. During image collection, a projector and fill-in lights were used to light up the calibration boards with different lighting conditions (i.e. different illumination set ups). To execute the algorithm, the binary templates of those calibration board are provided. To speed up the calibration target board area detection process, this algorithm allows the user to define which kind of calibration board he/she is looking for. FIG. 11 displays the typical outputs from the algorithm, which includes the multiple board regions in a greyscale input image, a label of identified calibration pattern, quantified unevenness of each board, the distribution of illumination on boards and marks for indicating the possible specular reflection points on boards. Similarly, more results from applying the algorithm across different levels of illumination problems for the same board and on images of different backgrounds and boards which demonstrated that with the increasing unevenness of the illumination, the value of metric U is raising, can be observed in FIG. 12 and FIG. 13, respectively. The experiment was also extended to show a wide range of performance across different boards with mild to gross illumination problems

The invention provides different methods for detecting saturation and uneven illumination on calibration target board images in order to help calibration technicians identify regions on a target board that shows illumination characteristics that can lead to calibration failure. Once the technician identifies such a region, the technician can make the decision to amend/change the illumination set up and/or reposition the calibration target board to an area for which lighting is more evenly/suitably distributed. The highlights of the methods are:

Method 1: saturation and uneven illumination (SU) detector procedure captured several illumination characteristics such as single-point specular highlight, multi-specular highlight, spotlight, shadow, but most importantly was able capture poor saturated images, especially ones which showed mild gradation in lighting.
Method 1: The SU detection method is applicable even on cluttered background images.
Method 1: The additional steps of pre-processing cluttered background images to localize a target board with user defined ROI and automated target board localization with Mask-RCNN are interesting additional features that are useful, but they introduce varying levels of computational cost to the SU detector processing.
Method 2: The contrast loss detection algorithm is able to detect illumination on target boards.
Method 2: The use of the covariance method to quantify uneven illumination in a target board image.
Method 2: The template matching method is shown to be useful for localizing the target board in cluttered background.

The detection of saturation and uneven illumination was successfully achieved using a smartphone camera and appropriate processing. When the effects of the lighting set up progresses from mild to gross the value of the metric for quantifying this effect increases. This means that the less the lighting effect on the target board the closer to zero the value will be.

The invention has primarily been described in relation to calibration target boards. It should however be appreciated that other calibration target means can be envisaged, such as electronic/optical display screens or light projections that will perform the function of such target boards.

1. A machine vision process comprising:
using an imaging device for imaging a calibration target in an illumination set up; and
processing the image in order to identify illumination problems; and
if illumination problems are identified, amending the illumination set up, and/or repositioning the target with respect to the vehicle and/or the illumination set up, and re-imaging the target.

2. A machine vision process according to claim 1, wherein the procedure is repeated until the imaging process provides a result that the illumination is satisfactory for the recalibration process to proceed.

3. A machine vision process according to claim 1, wherein the processing the image further comprises:
i) providing a calibration target and positioning the calibration target with respect to a vehicle;
ii) providing an illumination set up for illuminating the calibration target;
iii) operating the imaging device to image the target and processing the image to assess whether the illumination is satisfactory to proceed to a calibration phase;
iv) when the output of iii) is that the illumination is satisfactory, proceeding to implement a recalibration phase.

4. A machine vision process according to claim 1, wherein the imaging device comprises a camera and processor for processing data from the camera.

5. A machine vision process according to claim 1, wherein the imaging device comprises a smartphone having a camera and processor.

6. A machine vision process according to claim 1, wherein processing the image involves:
i) detection of saturation and uneven illumination (SU) regions in a calibration target image and;
ii) quantifying how much the target of interest deviates from a reference sample image that would pass the calibration test.

7. A machine vision process according to claim 1, wherein a processing step is included in which the image is processed to remove background objects separate from the calibration target.

8. A machine vision process according to claim 1, in which a processing step operates according to an algorithm in which different illumination characteristics are taken into consideration.

9. A machine vision process according to claim 8, in which the different illumination characteristics are a combination comprising two or more of the hue, saturation and value (HSV) colour system and a thresholding to determine the luminosity of each pixel of a calibration target formed by incoming light, and the reflectance property of the calibration target material.

10. A machine vision process according to claim 1, in which a processing step uses a reference image to compute target image deviation from a satisfactory illumination reference image for the given calibration target using the mean squared difference (MSD) function.

11. A machine vision process according to claim 10, in which the satisfactory illumination reference image is of a well-lit target board that is known to have passed a calibration test.

12. A machine vision process according to claim 1, in which a processing step operates according to an alternative contrast loss detection algorithm.

13. A machine vision process according to claim 12, in which the distribution of illumination on calibration target areas is analysed.

14. A machine vision process according to claim 12, in which:
i) an object detection method is used to locate calibration target areas in an image;
ii) an illumination free image is calculated with respect to the calibration target area; and
iii) distribution of light is derived subsequently by calculation.

15. A machine vision process according to claim 14, in which a process step applies a metric to describe the unevenness of light, and a heat map is generated to display the gradient of light reflected across the calibration target area.

16. A machine vision process according to claim 14, in which the illumination free image is calculated by means of an adaptive thresholding processing step.

17. A machine vision process according to claim 14, in which the background mode (dark or light) of the calibration target is determined by processing the image; and a binary image is generated by adaptive thresholding.

18. A machine vision process according to claim 17, wherein to calculate the illumination free image; following determination of the calibration target background, and the adaptive thresholding step:
i) white pixels are assigned with the average value for the corresponding white pixels in the original image; and,
ii) black pixels in the middle image are reassigned with a value from averaging the dark pixels in the original image.
